(19) United States
(12) Patent Application Publication
(10) Pub. No.: US 2006/0269854 A1
(43) Pub. Date: Nov. 30, 2006

(54) Color filter for solid-state image pickup apparatus and method of manufacturing the same

(75) Inventor: Hiroshi Taguchi, Shimada-City (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/442,330

(22) Filed: May 30, 2006

(30) Foreign Application Priority Data
May 31, 2005 (JP) 2005-159684

(51) Int. Cl. G02B 5/20

(52) U.S. Cl. 430/7; 257/432; 257/440

(57) ABSTRACT

The uppermost surface of a color filter to be used for a solid-state image pickup apparatus is forcibly oxidized to secure the ratio of the O=C—O bonds relative to the C—C bonds to not lower than a predetermined value so as to prevent cut pieces of Si and other metal foreign objects from re-adhering to the uppermost surface.

### CROSS-REFERENCE TO RELATED APPLICATIONS

This application is based upon and claims the benefit of priority from the prior Japanese Patent Application No. 2005-159684, filed on May 31, 2005; the entire contents of which are incorporated herein by reference.

### BACKGROUND OF THE INVENTION

(1) Field of the Invention

This invention relates to a color filter to be used for a solid-state image pickup apparatus to which metal foreign objects such as fine pieces of cut metal can hardly re-adhere and also to a method of manufacturing such a color filter.

(2) Description of the Related Art

Many solid-state image pickup apparatus such as CCDs and CMOS devices are made to pickup color images by arranging a color filter for each light receiving element thereof to produce a light receiving element/color filter pair in the trend of comprising ever increasing number of pixels in order to form fine images.

When preparing a color filters, color filter pixels are formed by means of color photoresist of the additive primary colors (red, blue, green) and those of the subtractive primary colors (cyan, magenta, yellow) and photolithography. While exposure apparatus for forming color filter pixels by means of photolithography include steppers and mirror projectors as well as ordinary aligners, steppers are being popularly used for solid-state image pickup apparatus having a large number of pixels for forming high definition images because they can meet the requirement of a positional accuracy of the order of sub-microns (see, inter alia, Jpn. Pat. Appln. Laid-Open Publication No. 2000-206310).

However, cut pieces of Si and other metal objects adhere to the surfaces of color filters of solid-state image pickup devices such as CMOS image sensors in a dicing step for a forming filter as a single chip. Such small pieces cannot be thoroughly removed by means of an established washing process to give rise to a problem of so-called black scars.

### BRIEF SUMMARY OF THE INVENTION

According to embodiments of the present invention, it is therefore the object of the present invention to provide a color filter to be used for a solid-state image pickup apparatus to which metal foreign objects such as fine pieces of cut metal can hardly re-adhere and also to a method of manufacturing such color filters.

The present invention may provide a color filter to be used for a solid-state image pickup apparatus, the color filter comprising:
a base layer formed on a transparent substrate to operate as base;
a coloring layer formed on the base layer and including a micro-pattern of the three primary colors of light;
an overcoat layer formed on the coloring layer to secure flatness; and
a lens layer formed on the overcoat layer to take in external light;
the surface condition of the lens layer being expressed as not less than 20% in terms of the ratio of O=C—O bonds relative to C—C bonds.

The present invention may provide a method of manufacturing a color filter to be used for a solid-state image pickup apparatus, the method comprising:
forming a base layer on a transparent substrate so as to make it operate as base;
forming a coloring layer including a micro-pattern of the three primary colors of light on the base layer;
forming an overcoat layer on the coloring layer to secure flatness;
forming a lens layer on the overcoat layer to take in external light; and
executing an oxidation process to the surface of the color filter.

### BRIEF DESCRIPTION OF THE DRAWINGS

FIGS. 1A and 1B are schematic views of an embodiment of color filter to be used for a solid-state image pickup apparatus according to the invention, illustrating the configuration thereof;

FIG. 2 is a schematic illustration of a comparison of the surface conditions of different color filters; and

FIG. 3 is a graph illustrating the relationship between the ratio of O=C—O bonds and the adhesion ratio of cut pieces.

### DETAILED DESCRIPTION OF THE INVENTION

Now, a color filter to be used for a solid-state image pickup apparatus according to the present invention will be described by referring to the accompanying drawings.

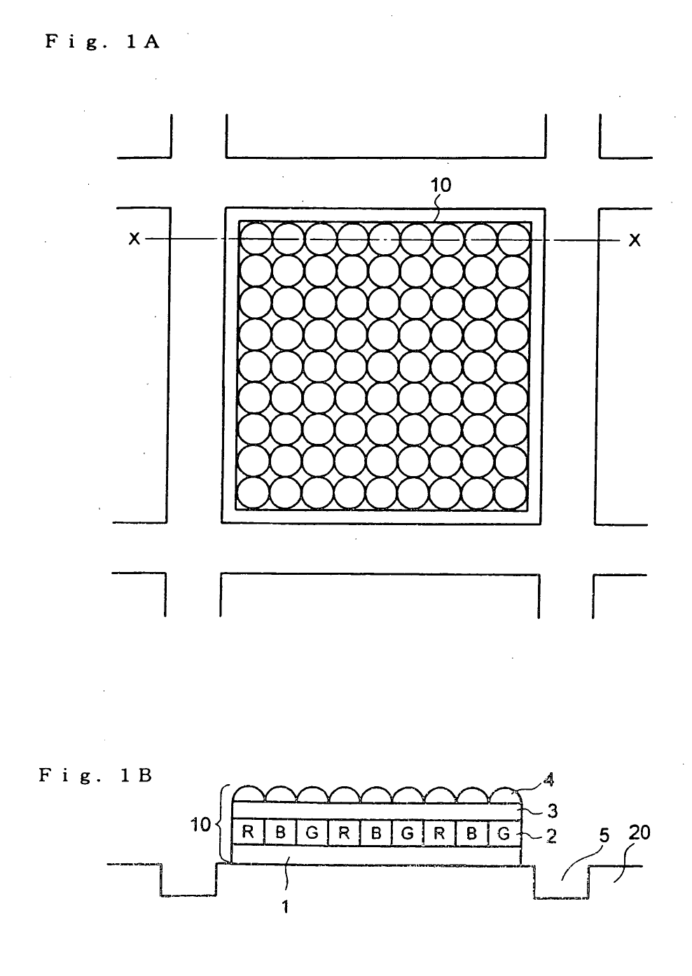

FIGS. 1A and 1B are schematic views of an embodiment of color filter to be used for a solid-state image pickup apparatus according to the invention, illustrating the configuration thereof. FIG. 1A is a plan view and FIG. 1B is a cross sectional view taken along line X—X in FIG. 1A.

The color filter is an optical member for coloring white light and comprises a filter layer 10 formed on a transparent substrate 20 that is made of Si. The filter layer 10 includes a base layer 1, a coloring layer 2, an overcoat layer 3 and a lens layer 4. These layers are formed typically by means of acrylic resin.

The base layer 1 is a transparent layer formed immediately on the transparent substrate 20 so as to operate as base for the filter layer.

The coloring layer 2 is formed on the base layer 1 and pixels of the three primary colors of red, blue and green are arranged regularly to form a micro-pattern. The micro-lenses of the lens layer 4 are arranged respectively in correspondence to the pixels.

In this embodiment, the coloring layer is formed by photolithography.

Firstly, a pigment dispersing solution (color resist) is applied onto the base layer 1 to form a film as a coloring layer 2. Such a color resist may typically be prepared by using a pigment, an alkali-soluble resin, a radial-polymerizing monomer, a photo-radical generating agent and a solvent.

Subsequently, the coloring layer 2 is exposed to light through a photo-mask.

Then, the coloring layer 2 that has been exposed to light is developed to form a monochromatically colored pattern.

Thereafter, the above-described process is repeated for each of the three primary colors.

The above described photolithography technique is not only simple when compared with other techniques such as a dyeing technique but also advantageous in terms of easiness of controlling spectral characteristics and reproducibility.

Then, an overcoat layer 3 is formed on the coloring layer 2 to improve the flatness of the color filter. It may typically be formed by means of thermosetting type acrylic resin.

Thereafter, a lens layer 4 is formed on the overcoat layer 3. The lens layer 4 is formed as a micro-lens array for taking in external light.

Then, the uppermost surface of the color filter that has been formed in the above-described manner is subjected to an oxidation process. Plasma oxidation that utilizes 0₂ gas can advantageously be used for the oxidation process. When 0₂ gas is used, it is possible to reduce the oxidation temperature to almost room temperature. Then, it is possible to suppress appearances of multilayer defects and transfers of such defects in the color filter and reduce redistribution of impurities so as not to unnecessarily damage the color filter.

As a high frequency wave or a microwave is applied to the oxygen atmosphere whose pressure is reduced to about 13 to 133 Pa, electrons that show an enhanced degree of energy collide with oxygen molecules to give rise to electrolytic dissociation and excitation of oxygen. Energy that is not lower than 13 eV is required for such electrolytic dissociation. Then, O⁻ and O²⁻ are produced. The movement of the produced negative oxygen ions is accelerated toward the color filter by the electric field existing there and then the ions drift along the interface. The surface of the color filter is modified as a result of such an oxidation process.

After the oxidation process executed to the uppermost surface of the color filter, it is cut along dicing streets 5 into chips of a predetermined size. The dicing operation is a machining operation and not only chippings but also powdery cut pieces are produced around the cut parts of the color filter. Therefore, the color filter is washed not only with pure water but also by spraying carbonate ion water in the dicing process for the purpose of reducing the degree of non-resistance and protecting the wired parts formed in the chips against impacts. The powdery cut pieces that contain Si as principal ingredient can be removed with ease by applying physical force by means of spraying.

The modified condition of the surface of the color filter of this embodiment of the present invention can be quantitatively observed for the chemical conditions of the adhering organic substances and their amounts by means of a non-destructive analysis using typically X-ray photoelectron spectroscopy (XPS).

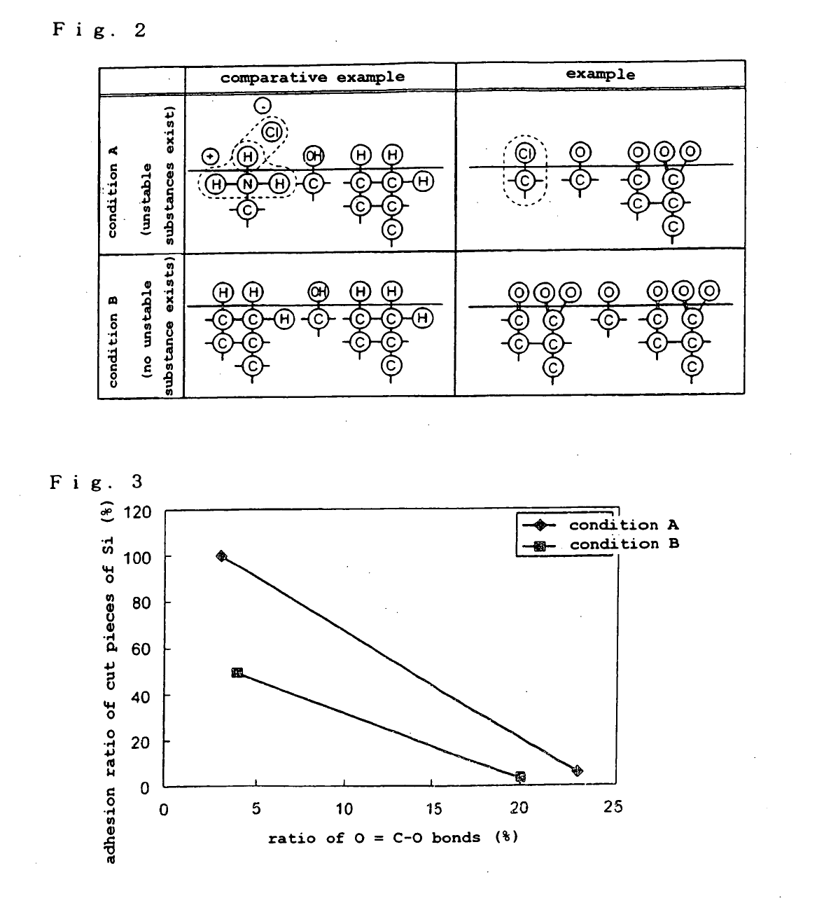

FIG. 2 is a schematic illustration of a comparison of the surface conditions of different color filters. The uppermost surface of a color filter according to the present invention subjected to an oxidation process and that of a similar color filter not subjected to any oxidation process are shown in FIG. 2 for the purpose of comparison. Additionally, condition A where unstable substances are found on the uppermost surface and condition B where no unstable substances are found on the uppermost surface are also shown for the purpose of comparison. Unstable substances as used herein refer to those that are in a condition where the energy levels of atoms and molecules are lowered and apt to move out of the respective steady states.

As shown in FIG. 2, the surface of the specimen of the comparative example is covered by OH groups or H groups, whereas the surface of the specimen of the present invention that is subjected to an oxidation process is covered by O groups and Cl groups are bonded to C groups on the surface.

FIG. 3 is a graph illustrating the relationship between the ratio of O=C—O bonds and the adhesion ratio of cut pieces. The adhesion ratio of cut pieces refers to the ratio of the number of chips to which cut pieces of Si are adhering relative to the total number of chips. The carbonyl group that is a functional group having a C—O double bond shows a strong ionic bond effect and hence a large adhesion ratio of cut pieces. Therefore, the adhering cut pieces of Si cannot be completely removed by repeating a washing process.

As shown in FIG. 3, the adhering cut pieces of Si cannot be removed if a washing process is repeated when the ratio of the O=C—O bonds on the surface is not more than 5% and the adhering cut pieces of Si remain adhering by substantially 100% in condition A where one or more than one unstable substances exist. On the other hand, the adhering cut pieces of Si remain adhering by about 50% in condition B where no unstable substance exists. Substantially all the cut pieces of Si are removed in an instance where the ratio of the O=C—O bonds on the surface is not less than 20% in condition B where no unstable substance exists. Also substantially all the cut pieces of Si are removed in an instance where the ratio of the O=C—O bonds on the surface is not less than 23% in condition A where one or more than one unstable substances exist.

Thus, according to the invention, it is possible to prevent cut pieces of Si and other metal foreign objects from re-adhering by forcibly oxidizing the uppermost surface of a color filter to be used for a solid-state image pickup apparatus and securing the ratio of the O=C—O bonds relative to the C—C bonds to be not less than a predetermined value.

Additionally, according to the present invention, if one or more than one unstable substances exist on the uppermost surface of a color filter to be used for a solid stat image pickup apparatus, it is possible to encourage them to be re-bonded to the uppermost surface of the color filter and stabilize them by subjecting the color filter to a plasma oxidation process.

It goes without saying that various obvious modifications and simple variants come within the scope of the present invention beyond the above-described embodiment.

What is claimed is:

1. A color filter to be used for a solid-state image pickup apparatus, the color filter comprising:
a base layer formed on a transparent substrate to operate as base;
a coloring layer formed on the base layer and including a micro-pattern of the three primary colors of light;
an overcoat layer formed on the coloring layer to secure flatness; and
a lens layer formed on the overcoat layer to take in external light;
the surface condition of the lens layer being expressed as not less than 20% in terms of the ratio of O=C—O bonds relative to C—C bonds.

2. The color filter according to claim 1, wherein
the transparent substrate is made of Si.

3. The color filter according to claim 1, wherein
the base layer is transparent.

4. The color filter according to claim 1, wherein
the base layer, the coloring layer, the overcoat layer and the lens layer are made of acrylic resin.

5. A color filter to be used for a solid-state image pickup apparatus having its uppermost surface subjected to an oxidation process to make the ratio of the O=C—O bonds relative to the C—C bonds not less than a predetermined value prior to a dicing process.

6. The color filter according to claim 5, wherein
the ratio is not less than 20%.

7. A method of manufacturing a color filter to be used for a solid-state image pickup apparatus, the method comprising:
forming a base layer on a transparent substrate so as to make it operate as base;
forming a coloring layer including a micro-pattern of the three primary colors of light on the base layer;
forming an overcoat layer on the coloring layer to secure flatness;
forming a lens layer on the overcoat layer to take in external light; and
executing an oxidation process to the surface of the color filter.

8. The method according to claim 7, wherein
the coloring layer is formed by way of a photolithography process.

9. The method according to claim 7, wherein
the oxidation process is a plasma oxidation process.

10. The method according to claim 9, wherein
the plasma oxidation process utilizes 0₂ gas.

11. The method according to claim 9, wherein
a high frequency wave or a microwave is applied in oxygen atmosphere in the oxidation process.

12. The method according to claim 11, wherein
the pressure of the oxygen atmosphere is reduced to 13 to 133 Pa.
